(19) United States
(12) Patent Application Publication
(10) Pub. No.: US 2018/0173153 A1
(43) Pub. Date: Jun. 21, 2018

(54) CLEANING BLADE, IMAGE FORMING UNIT AND IMAGE FORMING APPARATUS

(71) Applicant: Oki Data Corporation, Tokyo (JP)

(72) Inventor: Yoshihiro KANNO, Tokyo (JP)

(21) Appl. No.: 15/844,933

(22) Filed: Dec. 18, 2017

(30) Foreign Application Priority Data
Dec. 19, 2016 (JP) 2016-245089

(51) Int. Cl. G03G 21/00

(52) U.S. Cl. CPC G03G 21/0017

(57) ABSTRACT

A cleaning blade for removing residual toner on a surface of an image carrier, includes a fixed part to be held by a holder; and a free length part that is not held by the holder. Rebound resilience at 25° C. of a material of the cleaning blade is not lower than 11% and not higher than 36%, and an amount of plastic deformation at 25° C. of the material is not greater than 2.4 N×mm.

### BACKGROUND OF THE INVENTION

### 1. Field of the Invention

The present invention relates to an image forming unit and an image forming apparatus, and particularly relates to a cleaning blade for the image forming unit.

### 2. Description of the Related Art

Conventionally, there has been an apparatus in which a cleaning blade of which the rebound resilience is 5% to 22% is used as a cleaning blade for removing toner which adheres to a photosensitive drum. For example, see Japanese Patent Application Publication No. 2015-225164, paragraph 0053 and FIG. 1.

However, it is not possible to sufficiently prevent an external additive of the toner from passing between the photosensitive drum and the cleaning blade, and thus it is difficult to suppress deterioration of image quality.

### SUMMARY OF THE INVENTION

A cleaning blade according to the present invention is a cleaning blade for removing residual toner on a surface of an image carrier, and includes a fixed part to be held by a holder; and a free length part that is not held by the holder. Rebound resilience at 25° C. of a material of the cleaning blade is not lower than 11% and not higher than 36%, and an amount of plastic deformation at 25° C. of the material is not greater than 2.4 N×mm.

An image forming unit according to the present invention includes an image carrier; and a cleaning blade for removing residual toner on a surface of the image carrier. Rebound resilience at 25° C. of a material of the cleaning blade is not lower than 11% and not higher than 36%, and an amount of plastic deformation at 25° C. of the material is not greater than 2.4 N×mm.

According to the present invention, it is possible to prevent the external additive of the toner from passing through the contact part where the cleaning blade touches the surface of the photosensitive drum.

### BRIEF DESCRIPTION OF THE DRAWINGS

In the attached drawings:

FIG. 1 is a diagram showing main components of an image forming apparatus including an image forming unit according to an embodiment of the present invention;

FIG. 2 is a diagram showing main components of the image forming unit according to the present embodiment;

FIG. 3 is a diagram showing a result of the measurement of the amount of plastic deformation as a graph with a horizontal axis representing an indentation depth and a vertical axis representing a load;

FIGS. 4A and 4B are diagrams for explaining passing of a longitudinal streak of an external additive: FIG. 4A shows occurrence of a gathered cluster of the external additives;

FIG. 4B shows a state in which passing of the gathered cluster of the external additives has occurred; and

FIG. 5 is a diagram showing results of evaluation of tested samples of a cleaning blade, that is, samples A to W, in a coordinate plane with a vertical axis representing the amount of plastic deformation (N×mm) and a horizontal axis representing the rebound resilience Rb (%).

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from the detailed description.

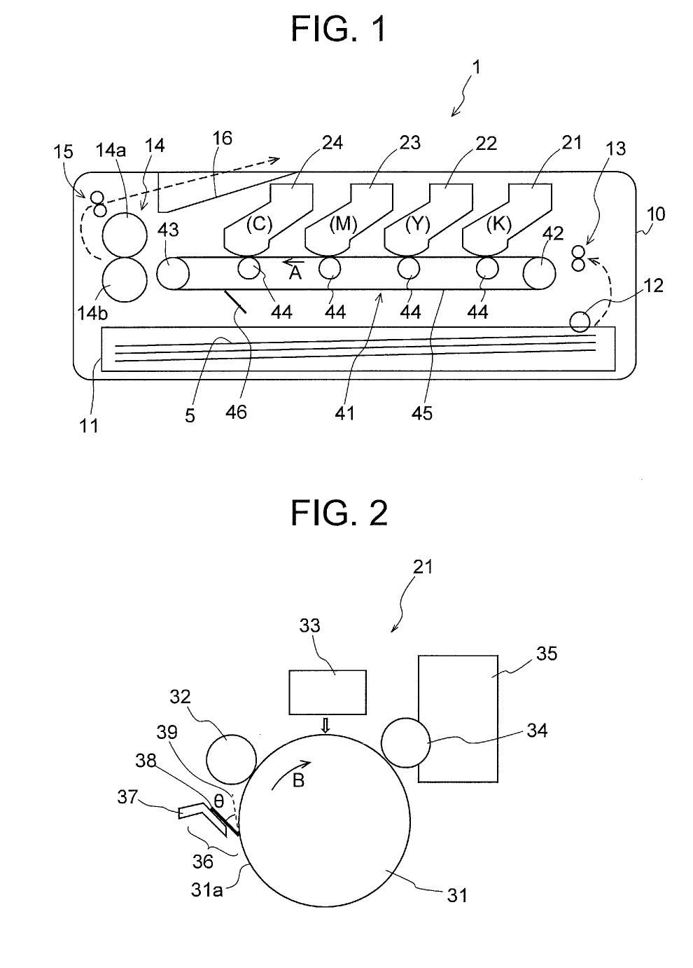

FIG. 1 is a diagram showing main components of an image forming apparatus that includes an image forming unit according to an embodiment of the present invention. FIG. 2 is a diagram showing main components of the image forming unit.

In FIG. 1, inside a housing 10, the image forming apparatus 1 includes a sheet feeding cassette 11 for accommodating a recording sheet 5 as a medium; a hopping roller 12 for taking out the recording sheet 5 from the sheet feeding cassette 11; and a resist roller pair 13 for correcting skew of the recording sheet 5 and conveying the sheet to an image forming section. Moreover, inside the housing 10, the image forming apparatus 1 includes image forming units 21, 22, 23 and 24, as the image forming section, which form toner images of black (K), yellow (Y), magenta (M) and cyan (C) respectively. The image forming units 21 to 24 are arranged in this order from an upstream side, along a conveyance path for conveying the recording sheet 5 in an arrow-A direction.

The image forming units 21 to 24 are similarly configured, except using the predetermined different colors of toner. Here, a configuration of the image forming unit 21 for black (K) will be described, as an example, by referring to FIG. 2.

The image forming unit 21 includes a photosensitive drum 31 as an image carrier, a charging roller 32 as a charging device, a developing roller 34 as a developer carrier, a toner cartridge 35 as a developer container for accommodating the toner, a cleaning unit 36, and so on. The developing roller 34 faces the photosensitive drum 31 and supplies the toner to a surface 31a of the photosensitive drum 31.

As shown in FIG. 2, the LED head 33 as an exposure device is disposed in an upper part of the image forming unit so as to face the photosensitive drum 31. Below the image forming units 21 to 24, a transfer unit 41 (FIG. 1) is disposed.

The transfer unit 41 includes a driving roller 43, a driven roller 42 disposed at a predetermined distance from the driving roller 43, a transfer belt 45, transfer rollers 44 and a cleaning blade 46. The transfer belt 45 is a belt member that is stretched by the driving roller 43 and the driven roller 42 and disposed movably in the arrow-A direction; the transfer belt 45 is disposed so as to be able to travel freely in the arrow-A direction. The transfer rollers 44 are transfer members disposed so as to face the respective photosensitive drums 31 in the image forming units 21 to 24 and so that the transfer belt 45 is interposed between the transfer rollers and the photosensitive drums. The cleaning blade 46 is a cleaning member disposed so that its edge (front end) touches the transfer belt 45.

The cleaning blade 46 is disposed for scraping off toner which is transferred from the photosensitive drum 31 (FIG. 2) and adheres to the transfer belt 45, toner of a toner image which is formed on the transfer belt 45 for density adjustment, and the like. At a stage subsequent to the transfer unit 41 in a sheet conveyance direction, a fixer 14 as a fixing unit is disposed. The fixer 14 includes a heat roller 14a and a pressure roller 14b disposed so as to face the heat roller 14a. A conveyance roller pair 15 conveys the recording sheet 5 onto which a toner image is fixed by the fixer 14 to an ejection roller pair (not shown in the drawing). Then the recording sheet 5 is ejected onto a stacker 16 disposed outside the housing 10.

An overview of printing operation by the image forming apparatus 1 configured as above will be given.

When the hopping roller 12 disposed at a front end of the sheet feeding cassette 11 is rotated, the recording sheet 5 in the sheet feeding cassette 11 is fed one by one in a direction of a dotted arrow to be supplied to the resist roller pair 13. The resist roller pair 13 temporarily stops the fed recording sheet 5, for correcting skew of the recording sheet 5. Then the resist roller pair 13 feeds the recording sheet 5 between the photosensitive drum 31 in the image forming unit 21 (FIG. 2) and the transfer belt 45 of the transfer unit 41.

Meanwhile, in each of the image forming units 21, 22, 23 and 24, the surface 31a of the photosensitive drum 31 (FIG. 2) is uniformly charged by the charging roller 32, the surface is then selectively exposed to light from light emitting elements of the LED head 33, and thus an electrostatic latent image as a latent image is formed. In FIG. 2, toner accommodated in the toner cartridge 35 is supplied by a toner supply roller (not shown in the drawing) formed with urethane sponge or the like to the developing roller 34, the developing roller 34 makes the toner a thin layer by using a developing blade (not shown in the drawing), and then the toner is adhered to the electrostatic latent image. A toner image as a developer image is thus formed on the photosensitive drum 31.

The recording sheet 5 fed from the resist roller pair 13 is conveyed between the photosensitive drums 31 in the image forming units 21 to 24 and the transfer rollers 44, while the transfer belt 45 travels. At the time, a voltage opposite to the toner image in polarity is applied onto each of the transfer rollers 44, toner images on the respective photosensitive drums 31 in the image forming units 21 to 24 are successively transferred onto the recording sheet 5 on top of each other by electrostatic force, and thus a color toner image is formed on the recording sheet 5.

Then the recording sheet 5 is conveyed to the fixer 14, and the color toner image is fixed onto the recording sheet 5, by being subjected to heat applied by the heat roller 14a and pressure applied by the pressure roller 14b. Then the recording sheet 5 is conveyed by the conveyance roller pair 15 and is ejected onto the stacker 16 outside the housing 10 by the ejection roller pair not shown in the drawing.

Even after the toner image on the photosensitive drum 31 is transferred onto the recording sheet 5, some toner (residual toner) adheres to, that is, remains on the surface 31a of the photosensitive drum 31. The residual toner on the surface 31a of the photosensitive drum 31 is scraped off and removed by the cleaning unit 36 (FIG. 2), with movement of the photosensitive drum 31. The movement is rotation of the photosensitive drum 31 in the present embodiment.

Next, the cleaning unit 36 will be described in detail. In the present embodiment, the outer diameter of the photosensitive drum 31 is 30 mm.

The cleaning unit 36 includes a plate-shaped cleaning blade 38 as a cleaning member and a holder 37 for holding the cleaning blade 38. The holder 37 is attached to a case of each of the image forming units 21 to 24 or the like. The cleaning blade 38 is disposed so that its edge touches the surface 31a of the photosensitive drum 31 while a direction of the edge is counter to a direction of the rotation of the photosensitive drum 31, that is, the direction of the edge of the cleaning blade 38 is opposite to the direction of movement of the surface 31a of the photosensitive drum 31. The contact part where the edge of the cleaning blade 38 touches the surface 31a of the photosensitive drum 31 is on the surface 31a of the photosensitive drum 31 and linearly extends along a direction of an axis of the photosensitive drum 31. Accordingly, the residual toner on the surface 31a of the photosensitive drum 31 is scraped off by the cleaning blade 38, with the rotation of the photosensitive drum 31.

The cleaning blade 38 is made of an elastic body such as a rubber material and the holder 37 is made of a stiff material such as a metal material. In the present embodiment, SECC is used as the stiff material. The SECC is electrogalvanized sheet steel defined in JIS (Japanese Industrial Standards).

The cleaning blade 38 in the present embodiment includes a fixed part that is held by the holder 37, and a free length part that is not held by the holder 37 and elastically deformable or flexible. In order to improve accuracy of attachment of the cleaning blade 38 to the holder 37, if the length of the free length part is a free length, the free length of the cleaning blade 38 is not less than 6.5 mm and not more than 7.8 mm and a tolerance of the free length is ±0.15 mm. The thickness of the cleaning blade 38 is not less than 1.5 mm and not more than 2.0 mm. Here, the width of the cleaning blade 38 in the direction of the axis of the photosensitive drum 31 is 238 mm.

Next, a toner passing endurance test (Test 1) and a printing evaluation test (Test 2) will be described. These tests were conducted for examining occurrence states of passing of the toner between the photosensitive drum 31 and the cleaning blade 38 according to conditions of attachment of the cleaning blade 38 and materials of the cleaning blade 38. For the toner passing endurance test (Test 1), various attachment conditions were set. For the printing evaluation test (Test 2), multiple test samples of the cleaning blade 38 of various materials were prepared.

### (Toner Used in the Tests)

Toner used for the tests is non-magnetic single-component toner which is negatively charged and includes toner base particles containing at least a binder resin, with addition of an external additive such as inorganic fine powder and organic fine powder. The binder resin is not limited to a particular resin. However, it is preferable to use a polyester resin, a styrene-acrylic resin, an epoxy resin or a styrene-butadiene resin. To the binder resin, a release agent, a coloring agent and so on are added. Moreover, other additives such as a charge control agent, a conductivity adjustment agent, an agent for improving fluidity, an agent for improving cleanability and so on may be added to the binder resin as appropriate. The binder resin may be a mixture of multiple types of resin. In the tests, multiple kinds of non-crystalline polyester resins and a crystalline polyester resin with crystal structure are used as the binder resin.

The mean particle diameter of the toner is 6.0 μm and the circularity of the toner is 0.96. The mean particle diameter is measured by using ‘Coulter Multisizer 3’ manufactured by Coulter Corporation. The circularity is measured by using a flow particle image analyzer ‘FPIA-3000’ manufactured by Sysmex Corporation.

The release agent is not limited to a particular release agent, and the following well-known release agents are given as examples: low molecular weight polyethylene; low molecular weight polypropylene; an olefin copolymer; a microcrystalline wax; a paraffin wax; an aliphatic hydrocarbon wax such as a ‘Fischer-Tropsch wax’; an oxide of an aliphatic hydrocarbon wax such as an oxidized polyethylene wax; or a block copolymer made of them; a carnauba wax; a wax or the like containing, as its main ingredient, a fatty acid ester such as a montanic acid ester wax; a product of partially or totally deoxidation of a fatty acid ester or the like such as a deoxidized carnauba wax. It is effective that the amount of the release agent contained in the binder resin is 0.1 pbw to 20 pbw (parts by weight), preferably 0.5 pbw to 12 pbw, per 100 pbw of the binder resin. It is also preferable to use multiple kinds of wax.

The coloring agent is not limited to a particular coloring agent. As the coloring agent, it is possible to use one of dyes, pigments and the like conventionally used as toner coloring agents for black, yellow, magenta and cyan toner, and it is also possible to use some of them together. Specifically, the following are given as examples: carbon black, an iron oxide, phthalocyanine blue, Permanent Brown FG, Brilliant Fast Scarlet, Pigment Green B, Rhodamine B Base, Solvent Red 49, Solvent Red 146, Pigment Blue 15:3, Solvent Blue 35, quinacridone, Carmine 6B, Disazo Yellow and the like. The amount of the coloring agent contained in the binder resin is 2 pbw to 25 pbw, preferably 2 pbw to 15 pbw, per 100 pbw of the binder resin.

As the charge control agent, a well-known charge control agent can be used. In a case of negatively charged toner, an azo-complex charge control agent, a salicylate-complex charge control agent, a calixarene charge control agent and the like can be given as examples. The amount of the charge control agent contained in the binder resin is 0.05 pbw to 15 pbw, preferably 0.1 pbw to 10 pbw, per 100 pbw of the binder resin.

The toner external additive is added for improving environmental stability, charging stability, developability, fluidity and conservation. A well-known external additive can be used. The amount of the external additive contained in the binder resin is 0.01 pbw to 10 pbw, preferably 0.05 pbw to 8 pbw, per 100 pbw of the binder resin. In the present example, a few kinds of silica of 14 μm in mean particle diameter (positively charged and negatively charged), colloidal silica of 110 μm in mean particle diameter (negatively charged) and melamine of 200 μm in mean particle diameter (positively charged) are added to 100 pbw of the base particle so that the total amount is within the above range.

### (Method of Manufacturing Cleaning Blades Used in the Tests)

The cleaning blade 38 used in the tests is an elastic body made of a rubber material, and a polyurethane (polyurethane elastomer) manufactured from a polyol, an isocyanate and a curing agent as materials is used as the cleaning blade 38. Although the cleaning blade 38 in the present embodiment have predetermined material properties differently determined according to test results described later, the test samples will be sometimes explained here as the cleaning blade 38 without distinguishing between them, for convenience of explanation.

The polyol is not limited to a particular polyol as long as it is used for manufacturing a polyurethane; as the polyol, one of polyethylene adipate, polybutylene adipate, polyethylene butylene adipate and the like is solely used, or two or more kinds of them are used together.

The isocyanate is not limited to a particular isocyanate as long as it is used for manufacturing a polyurethane; as the isocyanate, tolylene diisocyanate, 4,4′-diphenylmethane diisocyanate (MDI), hexamethylene isocyanate, 1,4-cyclohexane diisocyanate and the like, and their isomers can be used.

As the curing agent, a mixture of a high molecular weight polyol, a low molecular weight diol and a low molecular weight triol is used. The high molecular weight polyol is not limited to a particular high molecular weight polyol, as long as it is used for manufacturing a polyurethane; as the high molecular weight polyol, polyethylene adipate (average molecular weight 2000) can be used. The low molecular weight diol is not limited to a particular low molecular weight diol, as long as it is used for manufacturing a polyurethane; as the low molecular weight diol, 1,4-butanediol, ethylene glycol, diethylene glycol, 1,6-hexanediol, neopentyl glycol and the like can be used. The low molecular weight triol is not limited to a particular low molecular weight triol, as long as it is used for manufacturing a polyurethane; as the low molecular weight triol, trimethylolpropane, triisopropanolamine and the like can be used.

The cleaning blade 38 made of a polyurethane is manufactured in the following manner, for example.

The polyol and the isocyanate are dehydrated, the dehydrated polyol and the dehydrated isocyanate are mixed, a reaction between them at a temperature of 70° C. to 140° C. and for 10 minutes to 120 minutes is caused, and the curing agent is added to a prepolymer obtained by this reaction. Then the prepolymer and the added curing agent are poured into a metal mold of a centrifugal casting machine preheated at a temperature of 150° C. to cure them for 25 minutes to 50 minutes, thereafter, a sheet-like body having the shape of a cylinder is taken out from the metal mold, and a blade member is obtained by cutting the sheet-like body into thin rectangles. The cleaning blade 38 is formed by the obtained blade member.

At the time, the rebound resilience Rb of the cleaning blade 38 in the present embodiment which is measured by a measurement method conforming to JIS K6255 is set to be not lower than 11% and not higher than 36%, at 25° C., on the basis of the printing evaluation test (Test 2) described later.

In general, if the rebound resilience Rb is low, a peak top temperature Tp of tan δ is high. Tan δ is loss tangent and is a ratio of the loss modulus to the storage modulus. If the rebound resilience Rb at 25° C. is lower than 11%, the peak top temperature Tp tends to be higher than 10° C. at a measurement frequency of 10 Hz. At a temperature below the peak top temperature Tp, the cleaning blade 38 becomes a glass state so that its shape cannot flexibly change in accordance with the surface 31a of the photosensitive drum 31. Thus, the edge of the cleaning blade 38 cannot satisfactorily follow the surface 31a of the photosensitive drum 31, and passing of the toner and the external additive between the cleaning blade 38 and the photosensitive drum 31 occurs. For this reason, it is desirable here that the peak top temperature Tp should be 10° C. or lower. Accordingly, the rebound resilience Rb is set to be 11% or higher in order to reduce image defects at a low temperature.

In the present embodiment, the amount of plastic deformation of the cleaning blade 38 is set to be not less than 1.3 N×mm and not more than 2.4 N×mm, on the basis of the printing evaluation test (Test 2) described later. “N×mm” indicates Newton millimeter and may be expressed as “Nmm”.

Here, a method of measuring the amount of plastic deformation of the cleaning blade prepared as a sample for the tests described later and measurement conditions (a) to (d) will be described below.

(a) For the measurement, ‘Nano Indenter G200’ manufactured by TOYO Corporation was used.
(b) As a measurement indenter, a ‘Berkovich (TB13289) indenter’ was used.
(c) The measurement was conducted at normal temperature and normal humidity, i.e., a temperature of 25° C. and a humidity of 50%.
(d) For the measurement, the rubber of the cleaning blade was used with no processing.

Since the indentation depth is approximately 10 μm in the measurement, if the thickness of the rubber is 1.5 mm or more, a pedestal on which the sample is set has no influence on the measurement.

The measurement method conforms to ISO 14577-1. The indenter is pushed against the surface, until a force of 5 mN is applied. Thereafter, the state in which the force of 5 mN is applied is kept for 25 seconds. Thereafter, the load is removed by taking 30 minutes for the load removal.

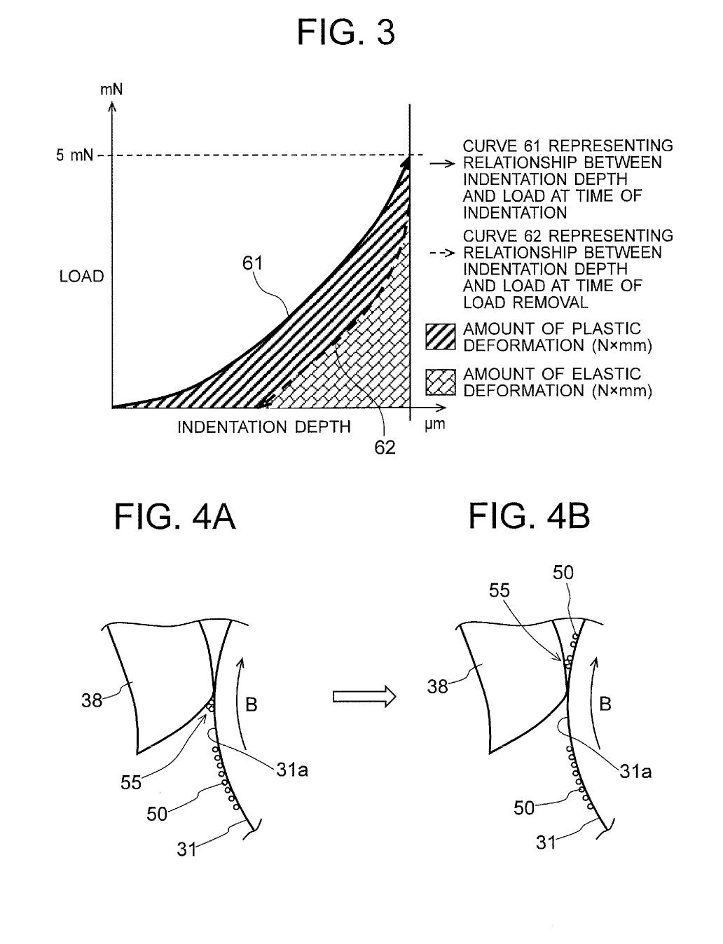

FIG. 3 is a diagram showing, as a graph, the result of the measurement of the amount of plastic deformation. In the graph, a horizontal axis represents an indentation depth and a vertical axis represents a load.

In FIG. 3, a solid line 61 is a curve representing a relationship between the indentation depth and the load at a time of indentation, and a dotted line 62 is a curve representing a relationship between the indentation depth and the load at a time of load removal. In FIG. 3, an area of a region surrounded by the solid line 61 and the dotted line 62 represents the amount of plastic deformation. The smaller the amount of plastic deformation is, the more excellent elasticity the rubber has against change in shape caused by microindentation.

If the amount of plastic deformation is zero, it means that it is an almost perfect elastic body. In manufacturing, it is difficult to make the amount of plastic deformation approximately zero. In the present example, the smallest amount of plastic deformation is 1.3 N×mm among the amount of plastic deformation of the tested cleaning blades.

The rebound resilience Rb and the amount of plastic deformation can be changed according to materials of the polyol, the isocyanate and the curing agent, or by adjusting the mixture proportion.

### (Test 1)

The toner passing endurance test (Test 1) will be described. The test was conducted by using the toner described above and by setting varieties of linear pressure and cleaning angles θ (FIG. 2) of the cleaning blade 38.

Here, in FIG. 2, a part on the surface 31a of the photosensitive drum 31 where the edge of the cleaning blade 38 touches the surface 31a of the photosensitive drum 31 is defined as the contact part; an angle θ formed between the cleaning blade 38 and a tangent line 39 of the surface 31a of the photosensitive drum at the contact part on a downstream side in a direction of movement of the surface 31a of the photosensitive drum 31, that is, a rotation direction (an arrow-B direction) here is referred to as the cleaning angle; pressure of the cleaning blade pressing the surface 31a of the photosensitive drum 31 at the contact part is referred to as the linear pressure. The contact part extends so as to be parallel to a rotation axis of the photosensitive drum 31 on the surface 31a of the photosensitive drum 31.

This toner passing endurance test (Test 1) was conducted under the following test conditions (1-1) to (1-4):

(1-1) For the test, a test apparatus (a color printer ‘C711dn’ manufactured by Oki Data Corporation) with the same basic configuration as the image forming apparatus 1 shown in FIG. 1 was used.
(1-2) Concerning the dimension of the cleaning blade 38, the free length was not shorter than 6.5 mm and not longer than 7.8 mm, and the thickness was not smaller than 1.5 mm and not greater than 2.0 mm, as described above.
(1-3) The test was conducted at normal temperature and normal humidity, i.e., a temperature of 25° C. and a humidity of 50%.
(1-4) Evaluation was made at a time point when a value counted by a drum counter (the number of rotation of the photosensitive drum 31 after the test starts) reached 5000. A case where no toner passing occurred until the above time point was marked with ‘GOOD’; a case where the toner passing occurred until the above time point was marked with ‘NOT GOOD’.

Table 1 shows the result and the evaluation of Test 1.

TABLE 1

| | LINEAR PRESSURE (gf/cm) | | | | |
|---|---|---|---|---|---|
| CLEANING ANGLE (°) | 10 | 20 | 25 | 30 | 35 |
| 9 | GOOD | GOOD | GOOD | GOOD | NOT |
| | | | | | GOOD |
| 16 | GOOD | GOOD | GOOD | GOOD | NOT |
| | | | | | GOOD |

As it is clearly known from the evaluation result shown in Table 1, it is considered that setting

the cleaning angle to be not smaller than 90 and not greater than 160, and

the linear pressure to be not lower than 10 gf/cm and not higher than 30 gf/cm,

makes it possible for the cleaning blade 38 in the present embodiment to prevent the toner passing due to wear of its edge or the like, until the time when the value counted by the drum counter reaches 5000 at least.

### (Test 2)

The printing evaluation test (Test 2) will be described below. The test was conducted by using the toner described above, by preparing samples of the cleaning blade 38, i.e., samples A to W, which have varieties of the rebound resilience and the amount of plastic deformation of the cleaning blade 38, and by equipping the image forming units 21 to 24 with the prepared samples.

For this Test 2, a test apparatus (a color printer ‘C711dn’ manufactured by Oki Data Corporation) of the same type as the image forming apparatus 1 shown in FIG. 1 was used. Operation of the image forming units 21 to 24 in the image forming apparatus 1 is as described above. During the operation, if the external additive passes between the photosensitive drum 31 and the cleaning blade 38, the passed external additive moves along the photosensitive drum 31 and undesirably adheres to the charging roller 32.

There are usually two types of the external additive adhesion to the charging roller 32, that is, adhesion of a grain of the external additive and adhesion of a longitudinal streak of the external additive. The adhesion of a grain of the external additive is caused because the external additive cannot be interrupted between the photosensitive drum 31 and the cleaning blade 38, and thus this causes graininess on a printed image. In other words, if the charging roller 32 is smudged, the potential on the surface 31a of the photosensitive drum 31 becomes uneven, and passing of a grain of the external additive causes image defects, such as dot variation in size and missing dots, in full-page halftone pattern printing.

The other type is the adhesion of a longitudinal streak of the external additive. FIGS. 4A and 4B are diagrams for explaining passing of a longitudinal streak of the external additive, and show enlarged views of the contact part where the cleaning blade 38 touches the photosensitive drum 31.

As shown in FIG. 4A, the external additive 50 is interrupted between the cleaning blade 38 and the photosensitive drum 31 which rotates in the arrow-B direction, and thus a gathered cluster 55 of the external additives 50 is produced. The cleaning angle, the linear pressure and stick-slip motion of the cleaning blade 38 are not completely even in a width direction (the direction of the axis of the photosensitive drum 31). Hence, stress concentrates at a particular point and passing of the gathered cluster 55 of the external additives 50 occurs, as shown in FIG. 4B.

After passing, the gathered cluster 55 is sandwiched between the photosensitive drum 31 and the cleaning blade 38 and continuously supplies the charging roller 32 with the external additives 50. This causes the external additives to adhere to the charging roller 32 in such a manner that a longitudinal streak of the external additive winds around the charging roller 32. At a place where the winding longitudinal streak of the external additive adheres, an increase in the thickness of the adhered external additives results in a charging failure and thus results in undesirable passing of a longitudinal streak of the external additive which causes a thick longitudinal streak as an image defect in full-page halftone pattern printing.

In the printing evaluation test (Test 2), printing was carried out by equipping the image forming units 21 to 24 with the prepared samples of the cleaning blade 38, i.e., the samples A to W, one by one, and occurrence tendencies of undesirable passing of a grain of the external additive and undesirable passing of a longitudinal streak of the external additive were examined.

This printing evaluation test (Test 2) was conducted under the following test conditions (2-A) to (2-H).

(2-A) By removing a roller for cleaning the charging roller 32 usually disposed in the image forming unit in the used test apparatus (a color printer ‘C711dn’ manufactured by Oki Data Corporation), the test apparatus was used under a condition that the external additive more easily winds around the charging roller 32.
(2-B) The cleaning angle of the cleaning blade 38 was set to be not smaller than 9° and not greater than 160; the linear pressure of the cleaning blade 38 was set to be not lower than 10 gf/cm and not higher than 30 gf/cm.
(2-C) The printing speed was set to be substantially 40 ppm (pages per minute) in A4 sized paper portrait orientation.
(2-D) Continuous printing of 2500 sheets per day was carried out for twelve days and thus 30000 sheets were printed in total (in a print mode of printing one sheet per one job).
(2-E) In continuous printing, a print pattern was printed at 0.3% Duty (a degree at which the toner is thinly transferred on the entire page).
(2-F) Printing was carried out by changing environmental conditions; the following conditions (2-F1) to (2-F3) were used in this order:
(2-F1) 12500 sheets at temperature 20° C., relative humidity 50%
(2-F2) 5000 sheets at temperature 28° C., relative humidity 80%
(2-F3) 12500 sheets at temperature 10° C., relative humidity 20%
(2-G) Cyan toner was used here. It is also possible to conduct an experiment using the four image forming units 21 to 24 at the same time, by dividing printing regions printed by the image forming units 21 to 24, in the width direction of the photosensitive drum 31, for printing.
(2-H) Concerning printing evaluation,

in full-page halftone pattern printing, if an image defect of graininess or a longitudinal streak occurred, it was judged as ‘NOT GOOD’ represented by a cross ‘x’.

In a case where the judgement result was other than ‘x’, the surface of the charging roller 32 was observed.

If the adhesion of a longitudinal streak of the external additive or the adhesion of a grain of the external additive occurred, it was judged as ‘GOOD’ represented by a circle ‘◯’ (because it was such slight adhesion that causes no image defect).

If neither the adhesion of a longitudinal streak of the external additive (winding) nor the adhesion of a grain of the external additive occurred, it was judged as ‘EXCELLENT’ represented by a double circle ‘◯’.

Table 2 shows the rebound resilience Rb and the amount of plastic transformation of the prepared samples of the cleaning blade 38, i.e., the samples A to W.

TABLE 2

| | REBOUND | AMOUNT OF | |
|---|---|---|---|
| | RESILIENCE | PLASTIC | |
| | (%) | TRANSFORMATION | EVALUATION |
| SAMPLE | at 25° C. | (N × mm) | RESULT |
| A | 17 | 4.6 | NOT GOOD |
| B | 30 | 4.8 | NOT GOOD |
| C | 25 | 5.0 | NOT GOOD |
| D | 19 | 2.8 | NOT GOOD |
| E | 36 | 3.5 | NOT GOOD |
| F | 40 | 3.6 | NOT GOOD |
| G | 28 | 3.3 | NOT GOOD |
| H | 47 | 2.0 | NOT GOOD |
| I | 9 | 1.3 | NOT GOOD |
| J | 11 | 2.7 | NOT GOOD |
| K | 38 | 1.3 | NOT GOOD |
| L | 30 | 1.3 | GOOD |
| M | 36 | 2.4 | GOOD |
| N | 35 | 2.1 | GOOD |
| O | 11 | 2.4 | GOOD |
| P | 36 | 1.3 | GOOD |
| Q | 20 | 2.2 | GOOD |
| R | 17 | 1.7 | EXCELLENT |
| S | 25 | 1.3 | EXCELLENT |
| T | 25 | 1.8 | EXCELLENT |
| U | 23 | 1.6 | EXCELLENT |
| V | 11 | 1.3 | EXCELLENT |
| W | 11 | 1.8 | EXCELLENT |

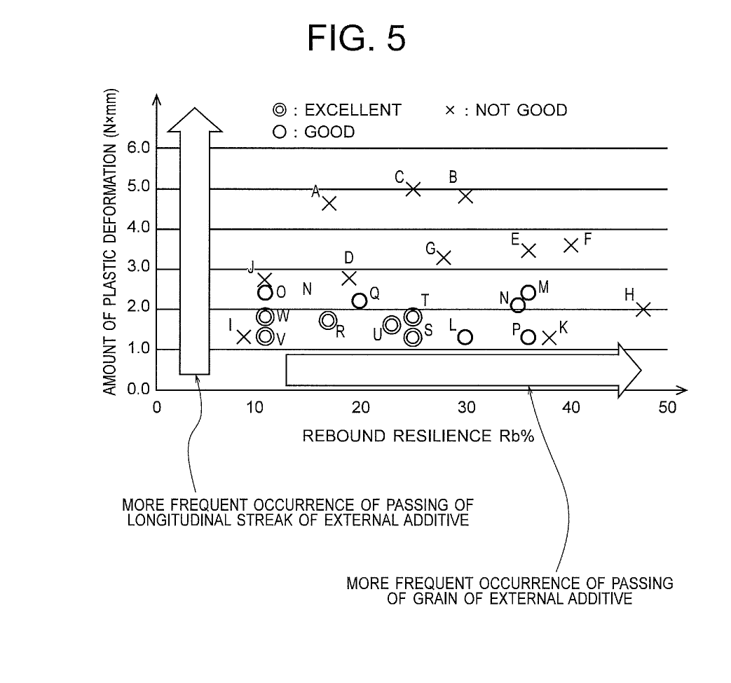

FIG. 5 is a diagram showing results of the evaluation of the tested samples A to W of the cleaning blade 38. In a coordinate plane in FIG. 5, the vertical axis represents the amount of plastic deformation (N×mm) and the horizontal axis represents the rebound resilience Rb (%), and corresponding coordinates are marked with symbols of crosses, circles, and double circles representing the evaluation results of “NOT GOOD”, “GOOD” and “EXCELLENT” respectively.

With reference to FIG. 5, a relationship between the amount of plastic deformation (N×mm) and the rebound resilience Rb (%), and the image defects of the graininess and the longitudinal streak will be considered.

As shown in FIG. 5, there are the following tendencies: the higher the rebound resilience Rb is, the more frequently the passing of a grain of the external additive occurs; the larger the amount of plastic deformation is, the more frequently the passing of a longitudinal streak of the external additive occurs. Accordingly, if the rebound resilience Rb is high or the amount of plastic deformation is large, it is judged as ‘NOT GOOD’ represented by the cross ‘x’.

If the rebound resilience Rb is high, the stick-slip motion of the edge of the cleaning blade 38 occurs within a large distance. Hence, the external additive 50 which is smaller than the toner easily passes between the cleaning blade 38 and the photosensitive drum, and accordingly the adhesion of a grain of the external additive to the charging roller 32 easily occurs. Consequently, the graininess is caused in full-page halftone pattern printing.

If the rebound resilience Rb is low and the amount of plastic deformation is large, the stick-slip motion of the edge of the cleaning blade 38 occurs within a small distance because the rebound resilience Rb is low, and it is difficult for the external additive 50 to pass between the cleaning blade 38 and the photosensitive drum 31. However, the external additive is interrupted and the interruption causes a gathered cluster of the external additives between the cleaning blade 38 and the photosensitive drum 31. In this case, the passing of the gathered cluster 55 of the external additives 50 between the cleaning blade 38 and the photosensitive drum 31 occurs as described above, and accordingly the winding of a longitudinal streak of the external additive around the charging roller 32 occurs.

If the rebound resilience Rb is low and the amount of plastic deformation is small, the gathered cluster of the external additives occurs between the cleaning blade 38 and the photosensitive drum 31, but the passing of the gathered cluster between the cleaning blade 38 and the photosensitive drum 31 does not occur. This is because the rubber material of the cleaning blade 38 has excellent elasticity against microindentation applied by the gathered cluster 55 of the external additives 50.

If the amount of plastic deformation is greater than 1.8 N×mm and not greater than 2.4 N×mm, the winding of a longitudinal streak of the external additive around the charging roller 32 occurs but the amount of the winding is small, and therefore no image defect is caused. Further if the amount of plastic deformation is not smaller than 1.3 N×mm and not greater than 1.8 N×mm, the winding of a longitudinal streak of the external additive around the charging roller 32 does not occur. If the amount of plastic deformation is smaller than 1.3 N×mm, elasticity of the rubber improves and it is considered that the winding of a longitudinal streak of the external additive around the charging roller 32 does not occur. However, in this Test 2, the evaluation was not conducted in the amount of plastic deformation smaller than 1.3 N×mm.

If the rebound resilience is higher than 25% and not higher than 36%, the graininess does not occur in full-page halftone pattern printing, but the adhesion of a grain of the external additive to the charging roller 32 occurs. If the rebound resilience is not lower than 11% and not higher than 25%, the adhesion of a grain of the external additive to the charging roller 32 does not occur.

If the rebound resilience is 9% or lower, the external additive adhesion to the charging roller 32 occurs. The reason is as follows: since the tan δ peak top temperature Tp is higher than 10° C., at a time of the evaluation at low temperature and low humidity of 10° C. and 20%, the cleaning blade 38 cannot satisfactorily follow the photosensitive drum 31, the passing of the external additive occurs, and the external additive adhesion to the charging roller 32 occurs.

On the basis of the test results and the printing evaluation result described above, the image forming unit in the present embodiment uses, as the cleaning blade 38, a cleaning blade having the following features: the rebound resilience Rb at normal temperature of 25° C. of the cleaning blade is not lower than 11% and not higher than 36%, and the amount of plastic deformation at normal temperature of 25° C. of the cleaning blade is not greater than 2.4 N×mm. It is more preferable to use a cleaning blade having the following features: the rebound resilience Rb at normal temperature of 25° C. of the cleaning blade is not lower than 11% and not higher than 25%, and the amount of plastic deformation at normal temperature of 25° C. of the cleaning blade is not smaller than 1.3 N×mm and not greater than 1.8 N×mm. Further, the cleaning angle of the cleaning blade 38 is set to be not smaller than 90 and not greater than 16°, and the linear pressure of the cleaning blade 38 is set to be not lower than 10 gf/cm and not higher than 30 gf/cm.

As described above, by limiting material properties and attachment conditions of the cleaning blade 38 in suitable setting ranges, it is possible for the image forming unit according to the present embodiment to prevent deterioration of printing quality caused by the adhesion of a grain or a streak of the external additive to the charging roller 32.

### INDUSTRIAL APPLICABILITY

The embodiment described above shows an example in which the present invention is applied to an image forming apparatus as a color printer. However, the present invention is not limited to this example and can be used for an image processor such as a copying machine, a facsimile and a multifunction printer (MFP). Although the image forming apparatus is a color printer in the above description, it may be a monochrome printer.

What is claimed is:

1. A cleaning blade for removing residual toner on a surface of an image carrier, the cleaning blade comprising:
a fixed part to be held by a holder; and
a free length part that is not held by the holder; wherein
rebound resilience at 25° C. of a material of the cleaning blade is not lower than 11% and not higher than 36%, and
an amount of plastic deformation at 25° C. of the material is not greater than 2.4 N×mm.

2. The cleaning blade according to claim 1, wherein the amount of plastic deformation is not smaller than 1.3 N×mm.

3. The cleaning blade according to claim 2, wherein the rebound resilience is not higher than 25% and the amount of plastic deformation is not greater than 1.8 N×mm.

4. The cleaning blade according to claim 1, wherein a tan δ peak top temperature of the material is not higher than 10° C. at a measurement frequency of 10 Hz.

5. An image forming unit comprising:
an image carrier; and
a cleaning blade for removing residual toner on a surface of the image carrier; wherein
rebound resilience at 25° C. of a material of the cleaning blade is not lower than 11% and not higher than 36%, and
an amount of plastic deformation at 25° C. of the material is not greater than 2.4 N×mm.

6. The image forming unit according to claim 5, wherein
linear pressure at a contact part where the cleaning blade touches the surface of the image carrier is set to be not lower than 10 gf/cm and not higher than 30 gf/cm, and
a cleaning angle formed between the cleaning blade and a tangent line of the surface of the image carrier at the contact part on a downstream side is set to be not smaller than 9° and not greater than 16°.

7. The image forming unit according to claim 5, further comprising a developer carrier that faces the image carrier and supplies toner to the surface of the image carrier.

8. The image forming unit according to claim 7, wherein the residual toner is toner remaining on the surface of the image carrier after a toner image formed on the surface of the image carrier is transferred.

9. The image forming unit according to claim 5, further comprising a holder that holds the cleaning blade.

10. The image forming unit according to claim 9, wherein
the cleaning blade includes a fixed part held by the holder, and a free length part that is not held by the holder, and
a length of the free length part is not less than 6.5 mm and not more than 7.8 mm.

11. The image forming unit according to claim 10, wherein the free length part touches the image carrier.

12. An image forming apparatus comprising the image forming unit of claim 5.
